(19) United States
(12) Patent Application Publication
(10) Pub. No.: US 2022/0136703 A1
(43) Pub. Date: May 5, 2022

(54) Portable Modular Oven

(71) Applicant: Byron Keith Elliott, Johnson City, TN (US)

(72) Inventor: Byron Keith Elliott, Johnson City, TN (US)

(21) Appl. No.: 17/507,057

(22) Filed: Oct. 21, 2021

Related U.S. Application Data
(63) Continuation-in-part of application No. 17/090,828, filed on Nov. 5, 2020.

(51) Int. Cl. F24C 1/16; A47J 37/06; A21B 1/52; F24C 15/10; F24B 1/00

(52) U.S. Cl. CPC F24C 1/16; A47J 37/0658; A47J 2201/00; F24C 15/101; F24B 1/003; A21B 1/52

(57) ABSTRACT

A portable modular oven provides a collapsible, portable and affordable cooking device that uses wood or charcoal as a heat source. Various components of the oven are preferably constructed of 22-gauge steel, with the exception of a rectangular ceramic cooking surface. The oven can be easily disassembled and its components can be stored inside its base portion to maximize portability. The oven is designed to be a proper pizza oven that can quickly reach temperatures well above 600° F. The height of the cooking surface may be adjusted, as well as the temperature, to accommodate oven baking of a multitude of food items. The oven is designed to be used at home, camping, or tailgating.

### RELATED APPLICATIONS

This application claims priority as a continuation-in-part of U.S. patent application Ser. No. 17/090,828, filed Nov. 5, 2020, titled “Portable Modular Oven,” the entire contents of which are incorporated herein by reference.

### FIELD

This invention relates to the field of ovens for cooking food. More particularly, this invention relates to a portable modular wood-fired oven.

### BACKGROUND

Conventional wood-fired ovens for cooking pizza and baking bread are typically constructed from brick and masonry cement, and are therefore very heavy and bulky. Although such ovens can be constructed on a trailer or bed of a truck to enhance transportability, the bulkiness of such ovens and their transport means significantly limits the locations in which they can be used. No conventional pizza ovens that use campfire logs for fuel are light enough to be easily transported to a variety of locales and be converted to a cooking griddle.

What is needed, therefore, is a compact, lightweight, and portable wood-fired oven that can be easily transported and used in small spaces with adequate ventilation.

### SUMMARY

The above and other needs are met by various embodiments of a modular oven that provides a collapsible, portable and affordable cooking device that uses wood or charcoal as a heat source. In one preferred embodiment, the oven is constructed of 22-gauge steel, and includes a 12-inch×16-inch ceramic cooking surface. The oven can be easily disassembled and its components can be stored inside its base portion to maximize portability. The oven is designed to be a proper pizza oven that can quickly reach temperatures well above 600° F. The height of the cooking surface may be adjusted, as well as the temperature, to accommodate oven baking of a multitude of food items.

A first embodiment of the modular oven includes a base portion, a middle portion, a removable upper portion, a cooking chamber, and a fire chamber. The middle portion may include opposed left and right side panels, a rear panel, and a cooking surface panel. The left and right side panels each have a rear edge and an upper edge. The rear panel has left and right edges and an upper edge, wherein the left and right edges are attached to the rear edges of the left and right side panels. The cooking surface panel is horizontally attached between the left and right side panels, and is vertically offset below the upper edges of the rear panel and the left and right side panels. A passageway is disposed between the rear panel and a rear edge of the cooking surface panel. The removable upper portion is configured to removably engage the upper edge of the rear panel and the upper edges of the left and right side panels of the middle portion. The cooking chamber is disposed between the cooking surface panel and the upper portion. The fire chamber is disposed below the cooking surface panel and between the left and right side panels of the middle portion, such that smoke and heat generated in the fire chamber pass through the passageway into the cooking chamber.

The base portion of the first embodiment may be configured to removably engage a lower edge of the rear panel and lower edges of the left and right side panels of the middle portion.

The upper portion of the first embodiment may include a plurality of tabs that extend downwardly from a bottom surface of the upper portion to removably engage the upper edges of the left side panel, right side panel, and rear panel.

The upper portion of the first embodiment may also include a lip that extends downwardly from a left edge, a right edge, and a rear edge of the bottom surface of the upper portion, and the plurality of tabs extend downwardly from the lip.

The middle portion of the first embodiment may include a plurality of slots disposed in the upper edges of the rear panel and the left and right side panels, and the plurality of tabs of the upper portion engage the plurality of slots in the upper edge of the rear panel and the upper edges of the left and right side panels when the upper portion engages the middle portion.

In the first embodiment, one or more vents may be disposed adjacent a lower edge of the left side panel, right side panel, and rear panel of the middle portion.

The first embodiment of the oven may include a removable grill attachment that is configured to removably engage the upper edges of the rear panel and the left and right side panels.

A second embodiment of a modular oven includes a vertical rear panel, opposed left and right vertical side panels, a horizontal cooking surface panel, a horizontal top panel, a passageway, a cooking chamber, a base portion, and a fire chamber. The rear panel has left and right edges, an upper edge and a lower edge. The left and right side panels each have a rear edge, a front edge, a bottom edge and an upper edge. The rear edge of each left and right side panel is removably attached to the rear panel adjacent to its left and right edges. The cooking surface panel is removably attached between the left and right side panels, and is vertically offset below the upper edge of the rear panel and the upper edges of the left and right side panels. The passageway is disposed between the rear panel and the rear edge of the cooking surface panel. The top panel is removably attached to the upper edge of the rear panel and the upper edges of the left and right side panels. The cooking chamber is disposed between the cooking surface panel and the top panel. The base portion has a horizontal upper surface to which the bottom edges of the left and right side panels are removably attached. The fire chamber—also referred to herein as the firebox—is disposed below the cooking surface panel, above the upper surface of the base portion, and between the left and right side panels. The components are arranged so that smoke and heat generated in the fire chamber pass through the passageway into the cooking chamber.

In some embodiments, the modular oven includes one or more vents disposed adjacent the bottom edges of the left side panel, the right side panel, and the rear panel.

In some embodiments, the rear panel has a pair of vertical slots disposed adjacent its left and right edges, and the left and right side panels each have a pair of vertical slotted tabs disposed on their rear edges. The rear edge of each left and right side panel is removably attached adjacent to the left and right edges of the rear panel by engagement of the vertical slotted tabs into the vertical slots.

In some embodiments, the left and right side panels each have at least one pair of horizontally-aligned slots disposed below their upper edges, and the cooking surface panel has opposing side edges with a pair of horizontal tabs disposed thereon. The cooking surface panel is removably attached between the left and right side panels by engagement of the horizontal tabs into the horizontally-aligned slots.

In some embodiments, the modular oven includes one or more firebox doors, each having an outer edge with a pair of vertically-aligned slotted hinge tabs thereon. One or both of the left and right side panels have a pair of vertically-aligned slots adjacent their front edges. The one or two firebox doors are removably attached to one or both of the left and right side panels by engagement of the pair of vertically-aligned slotted hinge tabs into the vertically-aligned slots.

In some embodiments, the left and right side panels each have a pair of slotted tabs on their bottom edges, and the base portion has two pairs of slots disposed in its upper surface. The bottom edges of the left and right side panels are removably attached to the upper surface of the base portion by engagement of the pairs of slotted tabs into the pairs of slots.

In another aspect, embodiments of the invention are directed to a method for assembling a modular oven. A preferred embodiment of the method includes:
(a) providing a horizontal base portion having an upper surface with slots therein;
(b) providing left and right vertical side panels, each having a rear edge, a front edge, a bottom edge and an upper edge, wherein each rear edge and bottom edge includes slotted tabs disposed thereon, wherein the left and right side panels each have at least one pair of horizontally-aligned slots disposed below their upper edges, and wherein a pair of vertically-aligned slots are disposed adjacent the front edge;
(c) providing a vertical rear panel having left and right edges, an upper edge, a lower edge, and vertically-aligned slots;
(d) inserting the slotted tabs on the rear edges of the left and right side panels into the vertically-aligned slots in the rear panel and sliding to engage;
(e) inserting the slotted tabs on the bottom edges of the left and right side panels into the slots in the upper surface of the base portion and sliding to engage;
(f) providing a horizontal cooking surface panel having side edges with tabs thereon;
(g) inserting the tabs on the side edges of the cooking surface panel into one of the pair of horizontally-aligned slots in the left and right side panels;
(h) providing a horizontal top panel;
(i) placing the horizontal top panel over the top edges of the left and right side panels and the rear panel;
(j) providing one or more firebox doors, each having an outer edge with slotted hinge tabs disposed thereon; and
(k) hanging the one or more firebox doors by inserting the slotted hinge tabs into the vertically-aligned slots at the front edges of the left and right side panels.

### BRIEF DESCRIPTION OF THE DRAWINGS

Other embodiments of the invention will become apparent by reference to the detailed description in conjunction with the figures, wherein elements are not to scale so as to more clearly show the details, wherein like reference numbers indicate like elements throughout the several views, wherein dimensions are in inches, and wherein:

FIG. 1 depicts a front perspective view of a modular oven according to a first embodiment of the invention;

FIG. 2 depicts a rear perspective view of the modular oven according to the first embodiment of the invention;

FIG. 3 depicts a front elevation view of the modular oven according to the first embodiment of the invention;

FIG. 4 depicts a right side elevation view of the modular oven according to the first embodiment of the invention;

FIG. 5 depicts a left side elevation view of the modular oven according to the first embodiment of the invention;

FIG. 6 depicts a rear elevation view of the modular oven according to the first embodiment of the invention;

FIG. 7 depicts an exploded front perspective view of the modular oven according to the first embodiment of the invention;

FIG. 8 depicts optional griddle and grill attachments for the modular oven according to the first embodiment of the invention;

FIG. 9 depicts a front perspective view of a modular oven according to a second embodiment of the invention;

FIG. 10 depicts a front elevation view of the modular oven according to the second embodiment of the invention;

FIG. 11 depicts a rear elevation view of the modular oven according to the second embodiment of the invention;

FIG. 12 depicts a side elevation view of the modular oven according to the second embodiment of the invention;

FIG. 13 depicts a top plan view of the modular oven according to the second embodiment of the invention;

FIG. 14 depicts a door of the modular oven according to the second embodiment of the invention;

FIG. 15 depicts a rear panel of the modular oven according to the second embodiment of the invention;

FIG. 16 depicts a base of the modular oven according to the second embodiment of the invention;

FIG. 17 depicts a side panel of the modular oven according to the second embodiment of the invention;

FIG. 18 depicts a top panel of the modular oven according to the second embodiment of the invention;

FIG. 19 depicts a cooking surface panel of the modular oven according to the second embodiment of the invention;

FIG. 20 depicts a door latch of the modular oven according to the second embodiment of the invention; and

FIG. 21 depicts a cross section view (corresponding to section line A-A in FIG. 13) of the modular oven according to the second embodiment of the invention.

### DETAILED DESCRIPTION

### First Embodiment

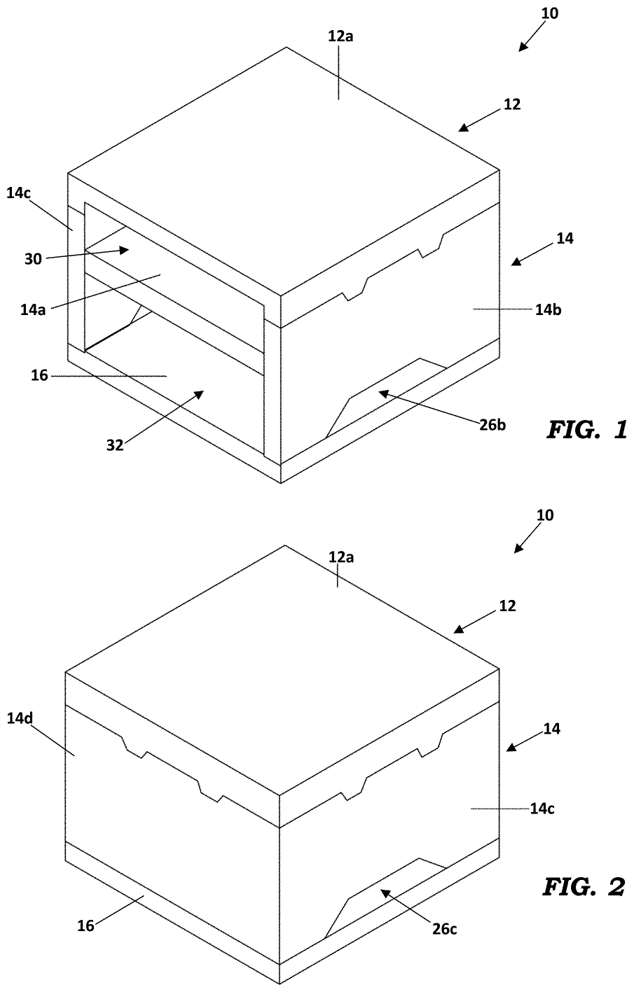

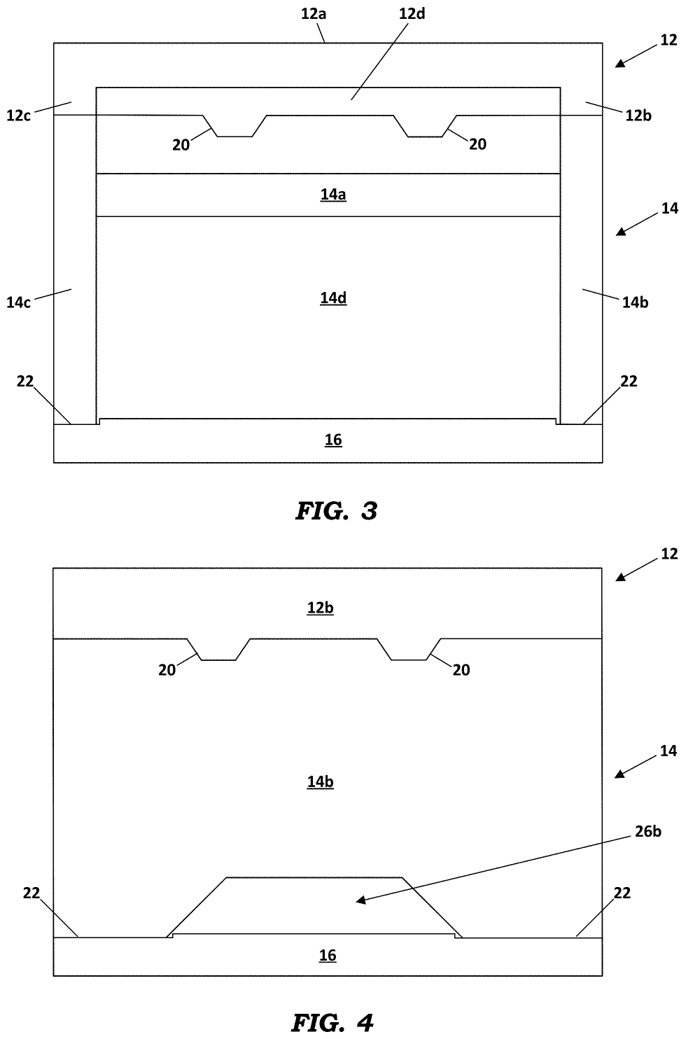

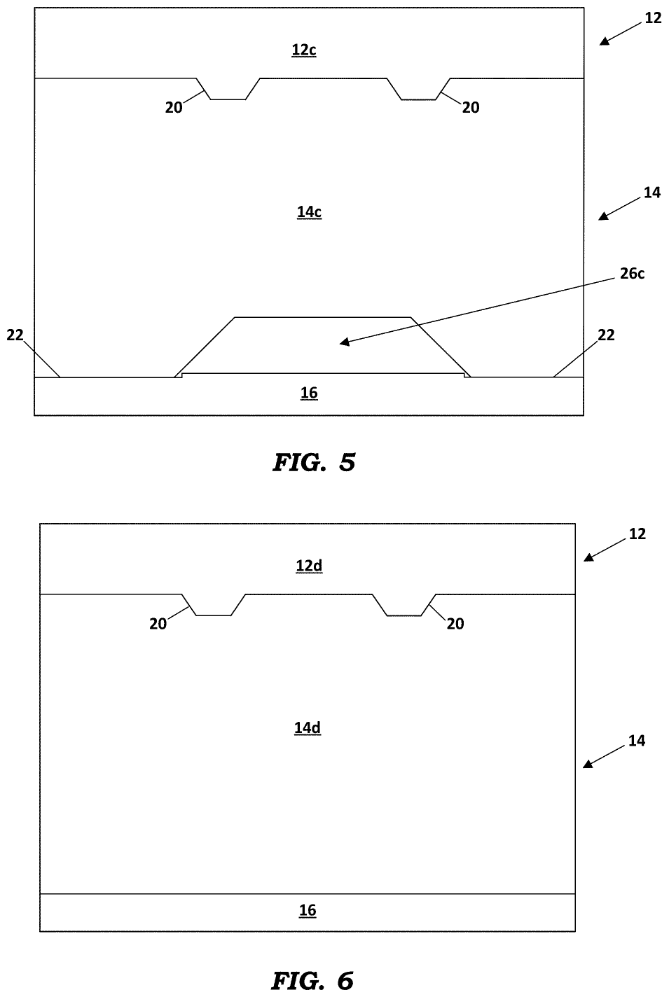

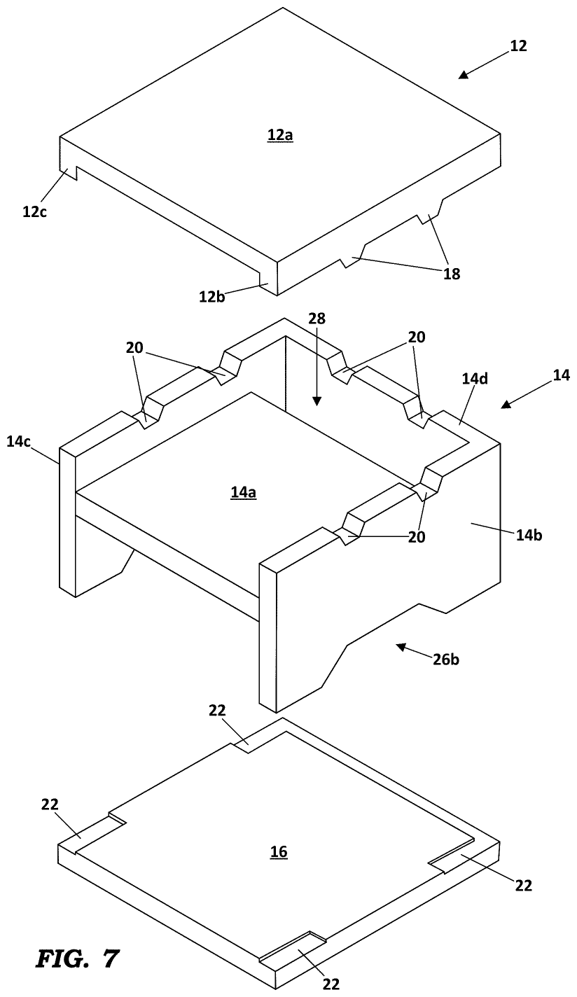

As shown in FIGS. 1-7, a first embodiment of a wood-fired oven 10 comprises three modular components, including an upper portion 12, a middle portion 14, and a base portion 16. Each of portions is preferably constructed from a ceramic material. As described in more detail below, the modular components may be disassembled for ease of transport and storage, and reassembled in a few easy steps when the oven is to be put in use.

The base portion 16 is preferably a rectangular horizontal panel having a depth of about 19½ inches, a width of about 15¾ inches, and a thickness of about 1½ inches, with inset regions 22 for receiving the lower edges of the middle portion 14.

The middle portion 14 preferably comprises four generally rectangular panels, including a horizontal cooking surface panel 14a, vertical side panels 14b and 14c, and a vertical rear panel 14d. The cooking surface panel 14a is preferably a rectangular plate having a depth of about 16 inches, a width of about 16 inches, and a thickness of about 1½ inches. The side panels 14b-14c are preferably rectangular plates, each having a height of about 10½ inches, a width of about 19½ inches, and a thickness of about 1½ inches. The rear vertical edges of the side panels 14b-14c are attached to the vertical edges of the rear panel 14d, and the left and right edges of the cooking surface panel 14a are attached to the inner surfaces of the side panels 14b-14c at a height of about 7 inches above the lower edges of the side panels 14b-14c. As shown in FIG. 1, a passageway 28 is provided between the rear panel 14d and the rear edge of the cooking surface panel 14a.

In one embodiment, the edges of the side panels 14b-14c, rear panel 14d, and cooking surface panel 14a are permanently attached together using fasteners or adhesive.

In another embodiment, the side panels 14b-14c, rear panel 14d, and cooking surface panel 14a are removably attached to one another, such as using removable pins, dovetail joints, or mortice and tenon joints. In this manner, the individual panels may be broken down and stacked flatly together for storage and transport.

In yet another embodiment, the side panels 14b-14c, rear panel 14d, and cooking surface panel 14a are integrally formed as a one-piece unit, such as in a molding process.

The upper edges of the side panels 14b-14c and the rear panel 14d preferably include multiple slots 20 that are engaged by corresponding tabs 18 on the upper portion 12, as described in more detail hereinafter.

The upper portion 12 preferably comprises a rectangular upper panel 12a and lip portions 12b, 12c, and 12d that extend downwardly from the upper panel 12a at its right side, left side, and rear edges. The height of the lip portions 12b-12d is about 2½ inches, and each lip portion includes multiple downwardly-extending tabs 18 that are about ¾ inches in height.

The first embodiment of the oven 10 is assembled by placing the upper portion 12 on top of the middle portion with the tabs 18 of the upper portion 12 aligned with the slots 20 in the middle portion 14, and placing the middle portion 14 on top of the base portion 16 with the lower edges of the middle portion 14 aligned with the inset regions 22 in the upper surface of the base portion 16. When the three components 12, 14, and 16 are so assembled as shown in FIG. 1, they form a cooking chamber 30 and a fire chamber 32. The cooking chamber 30 is in fluid communication with the fire chamber 32 via the passageway 28, so that smoke from the fire in the fire chamber 32 is drawn into the cooking chamber 30 and over the food cooking therein.

The first embodiment of the oven 10 includes vents 26b and 26c in the lower edges of the side panels 14b andl4c of the middle portion 14. The vents 26b and 26c allow air to be drawn into the fire chamber 32 to promote the flow of oxygen to the fire.

In the first embodiment, the assembled oven 10 has a total width of about 19 inches, a total depth of about 19½ inches, and a total height of about 14½ inches. At this size, it can easily fit within the fireboxes of most residential fireplaces.

It will be appreciated that particular dimensions are provided above to describe a first embodiment of the oven. Such exemplary dimensions do not limit the scope of the invention, as other dimensions may be used in other embodiments.

It should be noted that the base portion 16 may not be necessary in some situations, such as when the oven 10 is used inside the firebox of a fireplace, or on any other fireproof/firesafe surface. In such situations, the overall height of the oven may be reduced by the thickness of the base portion 16. This may be important when using the oven 10 in fireplaces having shorter fireboxes.

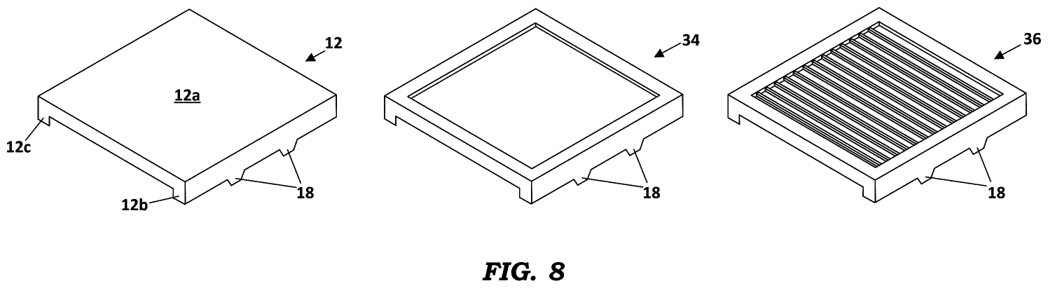

In one embodiment depicted in FIG. 8, the upper portion 12 of the oven 10 may be removed and replaced with a griddle attachment 34 or grill attachment 36, each of which preferably includes tabs 18 on the underside that engage the slots 20 in the upper edges of the middle portion 14. In this manner, the heat and smoke from the fire chamber 32 may be used for grilling meats or vegetables on the grill attachment 36, or for cooking pancakes, French toast, or eggs on the griddle attachment 34.

### Second Embodiment

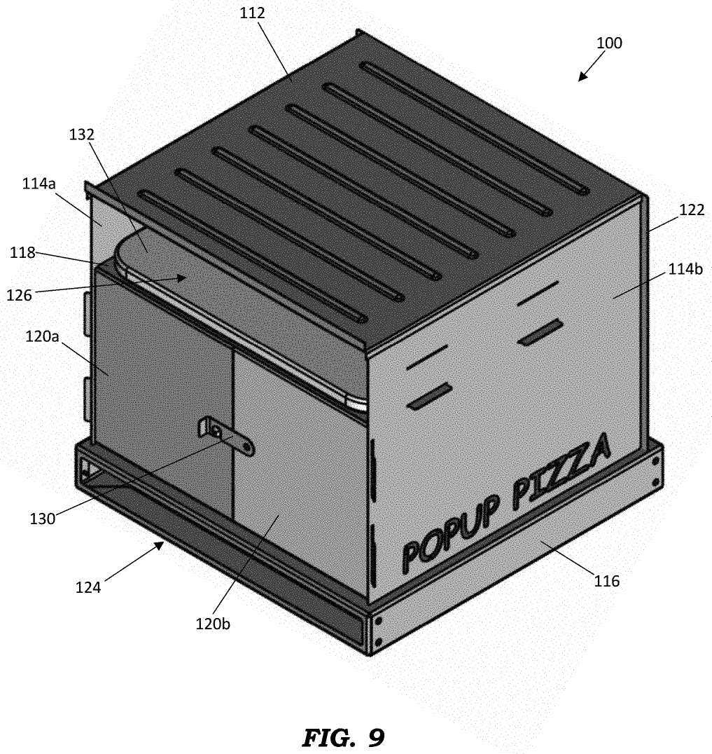

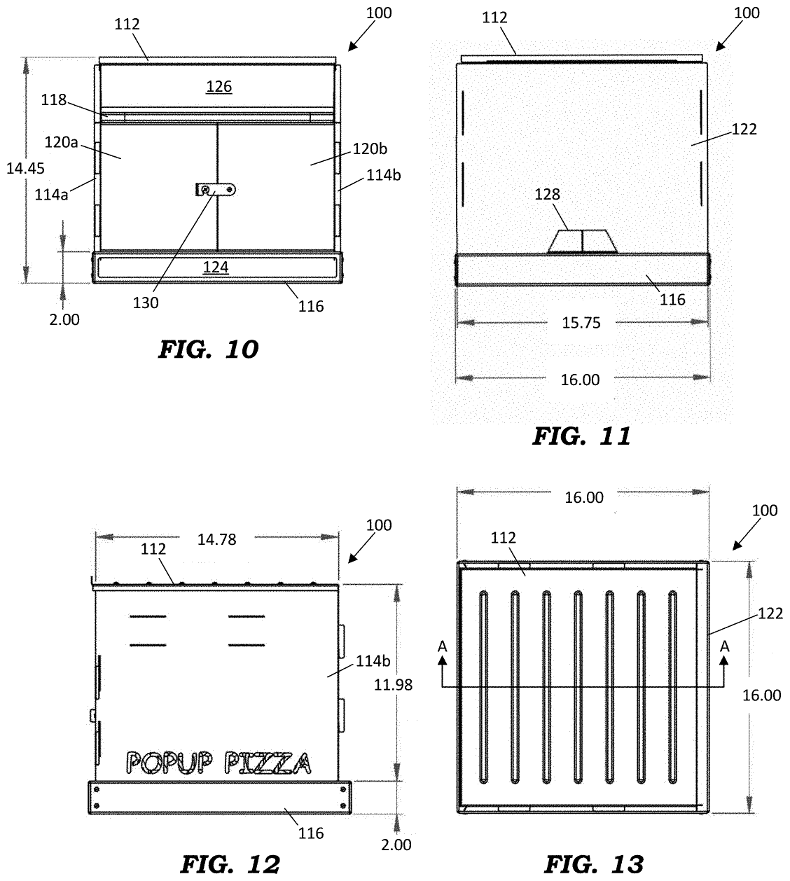

As shown in FIGS. 9-20, a second embodiment of a portable modular wood-fired oven 100 comprises eight modular components, including a top panel 112, two side panels 114a-114b, a base portion 116, a cooking surface panel 118, two firebox doors 120a-120b, and a rear panel 122. Each of the components is preferably constructed from metal, such as 22-gauge steel. As described in more detail below, the modular components may be disassembled for ease of transport and storage, and reassembled in a few easy steps when the oven is to be put in use.

As shown in FIG. 9, a cooking chamber 126 is formed in the space bounded by the top panel 112, the cooking surface panel 118, and the two side panels 114a-114b. The cooking chamber 126 is preferably sized to accommodate a ceramic cooking surface 132 having exemplary dimensions of 12-inches by 16-inches. A firebox 134—also referred to herein as a fire chamber—is formed in the space bounded by the cooking surface panel 118, the base portion 116, and the two side panels 114a-114b.

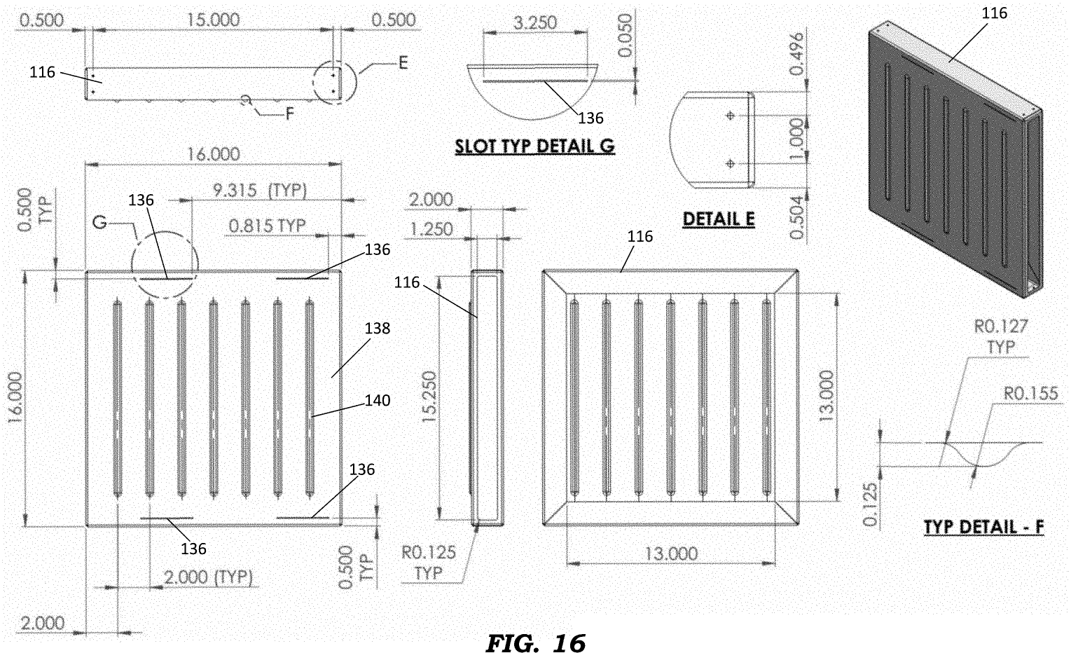

As shown in FIG. 16, the base portion 116 is preferably a rectangular box having an open bottom, and open front and rear ends that provide a space 124 for airflow. The base portion 116 has a depth of about 16 inches, a width of about 15.25 inches, and a height of about 2 inches. Two pairs of horizontally-aligned slots 136 are provided near the outer edges of the upper surface 138 of the base portion 116 for receiving corresponding slotted tabs 142 on the two side panels 114a-114b. Also in the upper surface 138 of the base portion 116 are a series of horizontal parallel stiffening ribs 140 that provide structural support for the upper surface 138.

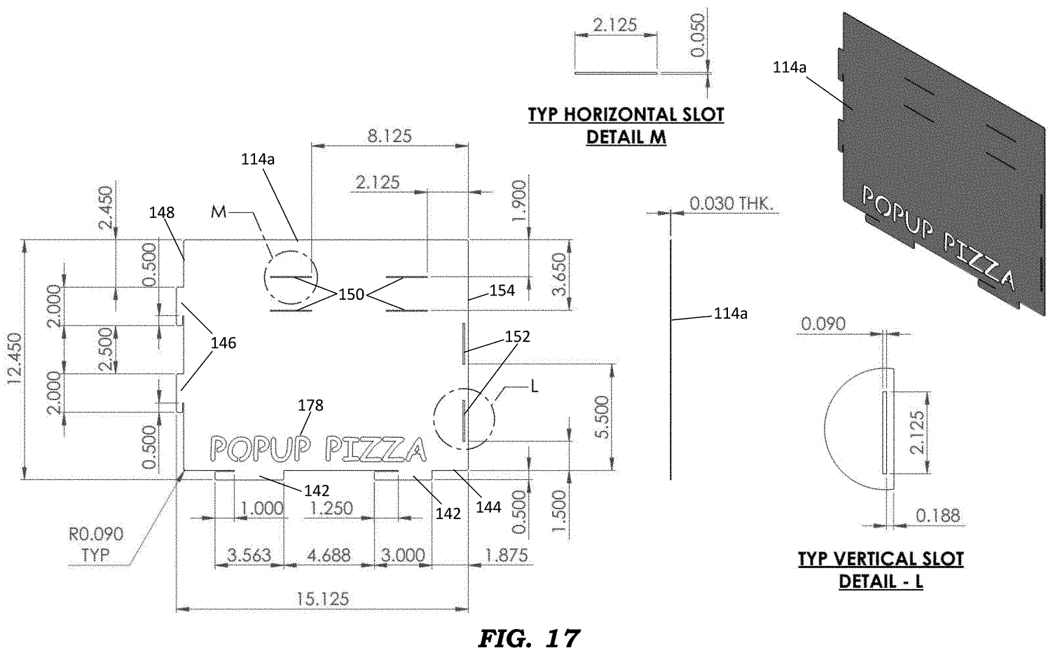

As shown in FIG. 17, each of the side panels 114a-114b includes the slotted tabs 142 along their bottom edges 144 that insert into the corresponding slots 136 in the upper surface 138 of the base portion 116, thereby securing the side panels 114a-114b to the base portion 116. Slotted tabs 146 are also provided on the rear edge 148 of each of the side panels 114a-114b for insertion into corresponding slots 156 in the rear panel 122. Two or more pairs of horizontally-aligned slots 150 at different vertical heights are provided in the upper portions of the side panels 114a-114b to receive corresponding tabs 166 on the cooking surface panel 118. A pair of vertically-aligned slots 152 are also provided near the front edge 154 of each of the side panels 114a-114b that receive corresponding slotted hinge tabs 162 on the firebox doors 120a-120b.

In a preferred embodiment, the side panels 114a-114b also have vent openings 178 disposed near their bottom edges 144 to allow air to flow to and from the firebox 134. The vent openings 178 may be in the shape of stenciled cutout letters of one or more words, such as “POPUP PIZZA” as shown in FIG. 17.

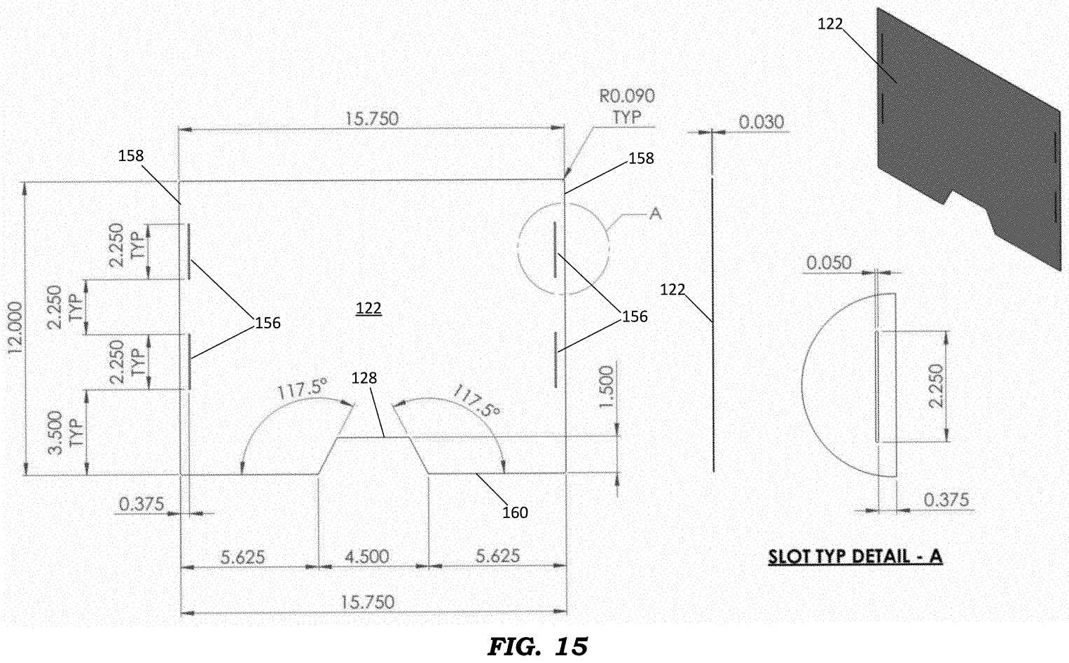

As shown in FIG. 15, the rear panel 122 has a pair of vertically-aligned slots 156 near each of its end edges 158 that receive the vertically-aligned slotted tabs 146 on the rear edges 148 of the side panels 114a-114b. The rear panel 122 also has a vent opening 128 centered on its bottom edge 160 to allow air to flow to and from the firebox 134.

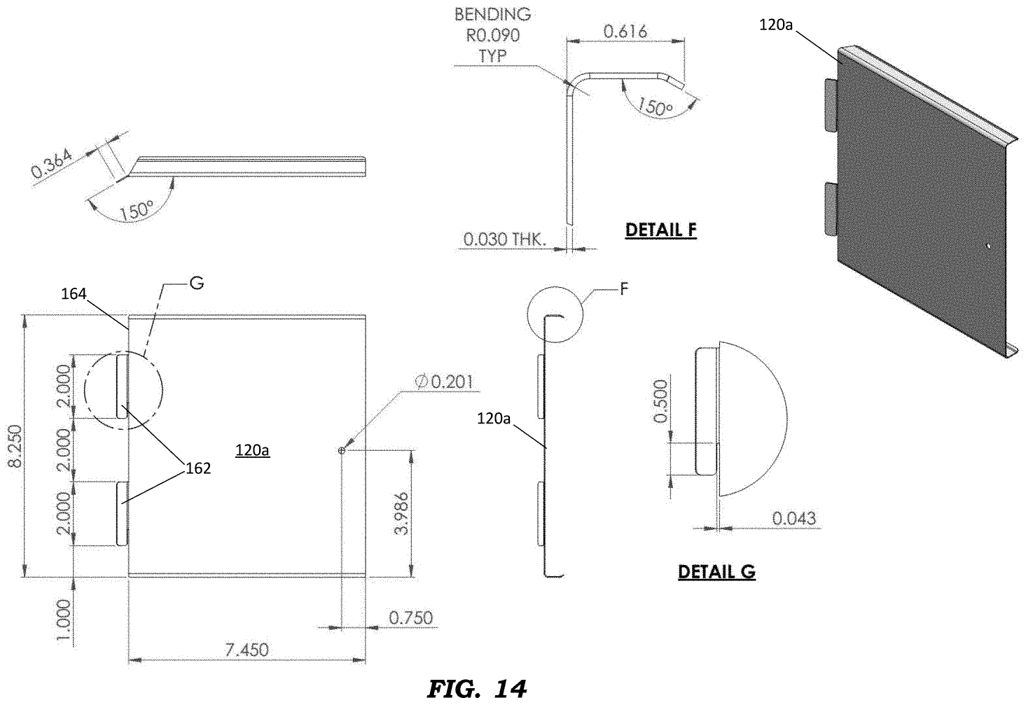

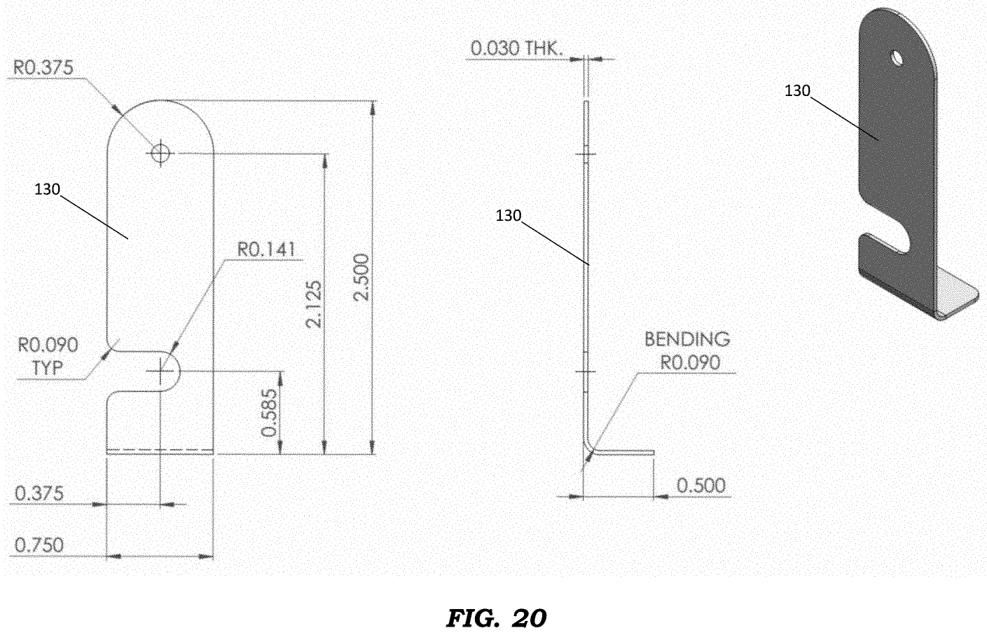

As shown in FIG. 14, each of the firebox doors 120a-120b includes a pair of vertically-aligned slotted hinge tabs 162 on its outer edge 164. These slotted hinge tabs 162 are received in the corresponding slots 152 on the front edges 154 of the side panels 114a-114b, and provide for securing the firebox doors 120a-120b to the side panels 114a-114b, while also allowing the firebox doors 120a-120b to swing outward with respect to the side panels 114a-114b to provide access to the firebox 134. A latch 130, the details of which are depicted in FIG. 20, is rotationally attached to the firebox door 120b and includes a slot that engages a protrusion extending from the firebox door 120b to secure the firebox doors 120a-120b in the closed position.

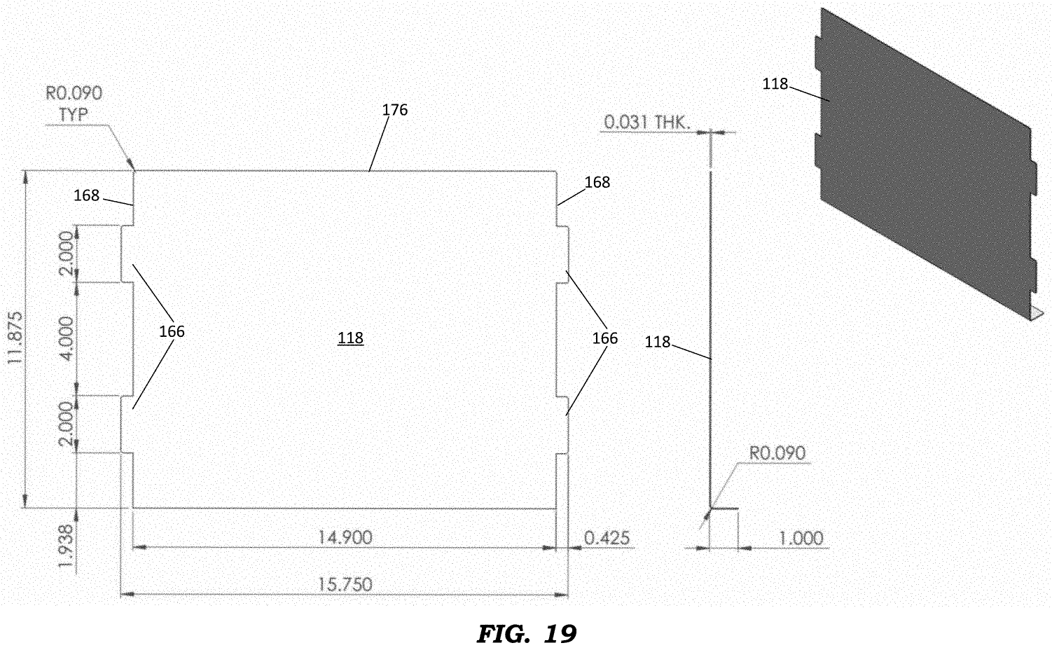

As shown in FIG. 19, the cooking surface panel 118 includes a pair of tabs 166 on each of its outer edges 168. These tabs 166 are received in the corresponding slots 150 provided at different vertical heights in the upper portions of the side panels 114a-114b.

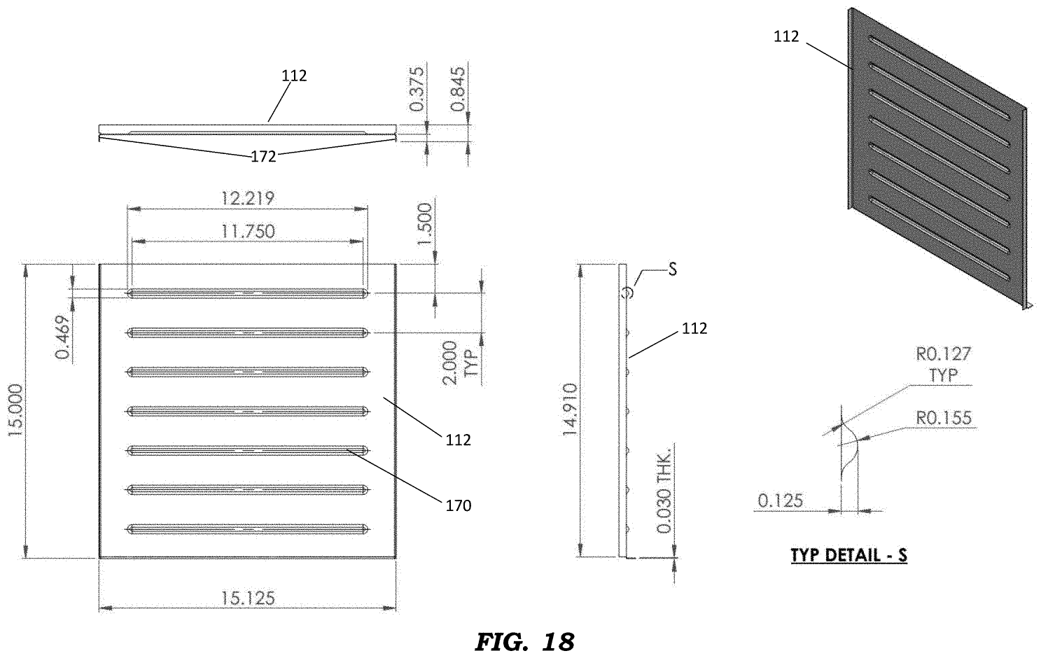

As shown in FIG. 18, the top panel 112 includes a series of horizontal parallel stiffening ribs 170 that provide structural support for the top panel 112. The side edges 172 of the top panel 112 are bent down at a 90-degree angle to capture the upper edges of the side panels 114a-114b and keep them in place in the final assembly.

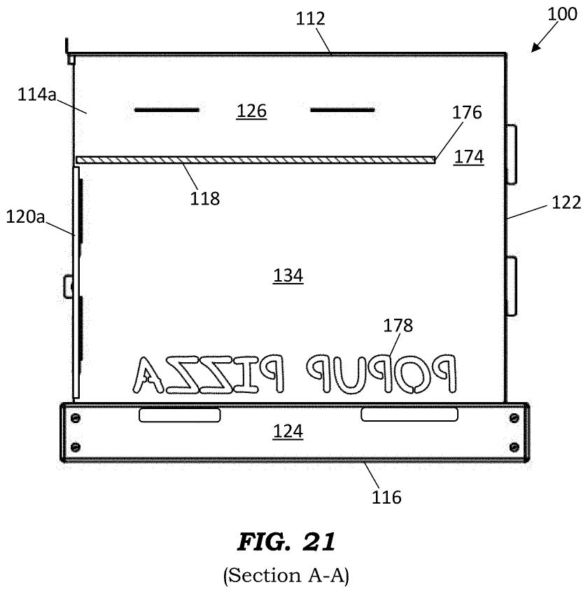

In preferred embodiments, such as depicted in FIG. 21, a passageway 174 is provided between the rear panel 122 and the rear edge 176 of the cooking surface panel 118. The passageway 174 provides fluid communication between the cooking chamber 126 and the firebox 134, so that smoke from the firebox 134 is drawn into the cooking chamber 126 and over the food cooking therein.

The second embodiment described above may be assembled according to the following steps:
Place the base portion 116 on a substantially horizontal surface.
Insert the slotted tabs on the rear edges of the left and right side panels 114a-114b into the slots in the rear panel 122 and slide to engage.
Insert the slotted tabs on the bottom edges of the left and right side panels 114a-114b into the slots in the top surface of the base portion 116 and slide to engage.
Insert the tabs on the side edges of the cooking surface panel 118 into the slots in the left and right side panels 114a-114b.
Place the top panel 112 over the top edges of the left and right side panels 114a-114b and the rear panel.
Hang the firebox doors 120a-120b by inserting the slotted hinge tabs on the outer edges of the firebox doors 120a-120b into the slots at the front edges of the left and right side panels 114a-114b.

The second embodiment described above may be disassembled by reversing the above steps. After disassembly, the top panel 112, left and right side panels 114a-114b, cooking surface panel 118, and firebox doors 120a-120b may be stored inside the space 124 in the base portion 116 for transport.

The foregoing description of preferred embodiments for this invention have been presented for purposes of illustration and description. They are not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A modular oven comprising:
a vertical rear panel having left and right edges, an upper edge and a lower edge;
opposed left and right vertical side panels, each having a rear edge, a front edge, a bottom edge and an upper edge, the rear edge of each left and right vertical side panel being removably attached to the vertical rear panel adjacent to the left and right edges of the vertical rear panel;
a horizontal cooking surface panel that is removably attached between the left and right vertical side panels, and vertically offset below the upper edge of the vertical rear panel and the upper edges of the left and right vertical side panels;
a passageway disposed between the vertical rear panel and a rear edge of the horizontal cooking surface panel;
a horizontal top panel that is removably attached to the upper edge of the vertical rear panel and the upper edges of the left and right vertical side panels;
a cooking chamber disposed between the horizontal cooking surface panel and the horizontal top panel;
a base portion having a horizontal upper surface, wherein the bottom edges of the left and right vertical side panels are removably attached to the horizontal upper surface of the base portion; and
a fire chamber disposed below the horizontal cooking surface panel, above the horizontal upper surface of the base portion, and between the left and right vertical side panels, such that smoke and heat generated in the fire chamber pass through the passageway into the cooking chamber.

2. The modular oven of claim 1 further comprising one or more vents disposed adjacent the bottom edge of one or more of the left vertical side panel, the right vertical side panel, and the vertical rear panel.

3. The modular oven of claim 1 wherein:
the vertical rear panel has a pair of vertical slots disposed adjacent the left and right edges of the vertical rear panel; and
the left and right vertical side panels each have a pair of vertical slotted tabs disposed on the rear edges of the left and right vertical side panels,
wherein the rear edge of each left and right vertical side panel is removably attached adjacent to the left and right edges of the vertical rear panel by engagement of the vertical slotted tabs into the vertical slots.

4. The modular oven of claim 1 wherein:
the left and right vertical side panels each have at least one pair of horizontally-aligned slots disposed below the upper edges of the left and right vertical side panels; and
the horizontal cooking surface panel has opposing side edges and a pair of horizontal tabs disposed on each of the opposing side edges,
wherein the horizontal cooking surface panel is removably attached between the left and right vertical side panels by engagement of the horizontal tabs into the horizontally-aligned slots.

5. The modular oven of claim 1 further comprising:
one or two firebox doors, each having an outer edge and a pair of vertically-aligned slotted hinge tabs on the outer edge; and
one or both of the left and right vertical side panels having a pair of vertically-aligned slots adjacent the front edge of one or both of the left and right vertical side panels,
wherein the one or two firebox doors are removably attached to one or both of the left and right vertical side panels by engagement of the pair of vertically-aligned slotted hinge tabs into the vertically-aligned slots.

6. The modular oven of claim 1 wherein:
the left and right vertical side panels each have a pair of slotted tabs on the bottom edges of the left and right vertical side panels; and
the base portion has two pairs of slots disposed in the horizontal upper surface of the base portion,
wherein the bottom edges of the left and right vertical side panels are removably attached to the horizontal upper surface of the base portion by engagement of the pairs of slotted tabs into the pairs of slots.

7. A method for assembling a modular oven, comprising:
(a) providing a horizontal base portion of the modular oven, the horizontal base portion having an upper surface with slots therein;
(b) providing left and right vertical side panels of the modular oven, wherein the left and right vertical side panels each have a rear edge, a front edge, a bottom edge and an upper edge, wherein each rear edge and bottom edge includes slotted tabs disposed thereon, wherein the left and right vertical side panels each have at least one pair of horizontally-aligned slots disposed below the upper edges of the left and right vertical side panels, and wherein a pair of vertically-aligned slots are disposed adjacent the front edge;
(c) providing a vertical rear panel having left and right edges, an upper edge and a lower edge, wherein the vertical rear panel has vertically-aligned slots therein;
(d) inserting the slotted tabs on the rear edges of the left and right vertical side panels into the vertically-aligned slots in the vertical rear panel and sliding to engage;
(e) inserting the slotted tabs on the bottom edges of the left and right vertical side panels into the slots in the upper surface of the horizontal base portion and sliding to engage;
(f) providing a horizontal cooking surface panel having side edges with tabs thereon;
(g) inserting the tabs on the side edges of the horizontal cooking surface panel into one of the pair of horizontally-aligned slots in the left and right vertical side panels;
(h) providing a horizontal top panel;
(i) placing the horizontal top panel over the top edges of the left and right vertical side panels and the vertical rear panel;
(j) providing one or more firebox doors, each having an outer edge with slotted hinge tabs disposed thereon; and
(k) hanging the one or more firebox doors by inserting the slotted hinge tabs into the vertically-aligned slots at the front edges of the left and right vertical side panels.

8. A modular oven comprising:
a middle portion comprising:
opposed left and right side panels, each having a rear edge and an upper edge, wherein the upper edge has one or more slots disposed therein;
a rear panel having left and right edges and an upper edge with one or more slots disposed therein, the left and right edges of the rear panel attached to the corresponding rear edges of the left and right side panels;
a cooking surface panel that is horizontally attached between the left and right side panels, and is vertically offset below the upper edges of the rear panel and the left and right side panels; and
a passageway disposed between the rear panel and a rear edge of the cooking surface panel;
a removable upper portion configured to removably engage the upper edge of the rear panel and the upper edges of the left and right side panels of the middle portion, the upper portion including:
a bottom surface having a left edge, a right edge, and a rear edge;
a lip that extends downwardly from the bottom surface; and
a plurality of tabs that extend downwardly from the lip and engage the one or more slots disposed in the upper edge of the rear panel and the upper edges of the left and right side panels;
a removable base portion comprising a bottom panel configured to removably engage a lower edge of the rear panel and lower edges of the left and right side panels of the middle portion;
a cooking chamber disposed between the cooking surface panel and the bottom surface of the upper portion; and
a fire chamber disposed between the cooking surface panel and the bottom panel of the base portion, such that smoke and heat generated in the fire chamber pass through the passageway into the cooking chamber.

9. The modular oven of claim 8 further comprising one or more vents disposed adjacent the lower edge of one or more of the left side panel, right side panel, and rear panel of the middle portion.

10. The modular oven of claim 8 further comprising a removable grill attachment configured to removably engage the upper edges of the rear panel and the left and right side panels.
